(19) United States
(12) Patent Application Publication
(10) Pub. No.: US 2020/0114214 A1
(43) Pub. Date: Apr. 16, 2020

(54) GOLF BALL

(71) Applicant: Sumitomo Rubber Industries, Ltd., Kobe-shi (JP)

(72) Inventors: Mami TANAKA, Kobe-shi, Hyogo (JP); Toshiyuki TARAO, Kobe-shi, Hyogo (JP)

(73) Assignee: Sumitomo Rubber Industries, Ltd., Kobe-shi (JP)

(21) Appl. No.: 16/653,568

(22) Filed: Oct. 15, 2019

(30) Foreign Application Priority Data
Oct. 16, 2018 (JP) 2018-195344

(51) Int. Cl. A63B 37/00; B29D 99/00; C08L 75/04

(52) U.S. Cl. CPC A63B 37/0024; A63B 37/0074; A63B 37/0075; B29K 2075/00; B29D 99/0042; C08L 75/04; A63B 37/0096; A63B 37/0043

(57) ABSTRACT

An object of the present invention is to improve the durability of the golf ball without substantially lowering the spin performance. The present invention provides a golf ball comprising a spherical core and a cover covering the spherical core, wherein the cover contains: (A) a base resin component, and (B) resin fine particles containing a polyrotaxane component having a cyclodextrin, a linear molecule penetrating the cyclic structure of the cyclodextrin in a skewering manner, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

### FIELD OF THE INVENTION

The present invention relates to a golf ball comprising a spherical core and a cover.

### DESCRIPTION OF THE RELATED ART

Properties of a golf ball such as resilience, durability and shot feeling are controlled, for example, by appropriately selecting a cover material.

For example, JP H10-314341 A discloses a golf ball cover material primarily containing a rubber modified thermoplastic resin composition obtained by blending a functional rubber-like copolymer in a base resin composed of an ionomer resin, a non-ionomer thermoplastic elastomer or a mixture thereof.

JP H11-104274 A discloses a golf ball cover composition composed of 50 to 90 parts by weight of an ionomer resin, 10 to 50 parts by weight of a diene rubber, and 0.1 to 5 parts by weight of a non-polluting antioxidant, wherein the diene rubber is dispersed in the ionomer resin, and the dispersed diene rubber has a particle size of 5 μm or less.

JP H6-319832 A discloses a golf ball cover composition obtained by blending a core-shell polymer (B) having a core (a) formed from a rubber-like polymer and a shell (b) formed from a glass-like polymer, in an ionic ethylene copolymer (A) having an ethylene-unsaturated carboxylic acid copolymer as a base resin.

JP 2007-159997 A discloses a golf ball comprising a core and a cover, wherein the cover contains a crosslinked polyurethane as a base resin, and the crosslinked polyurethane is obtained by heating and reacting a cover composition containing a thermoplastic polyurethane and a thermo-reactive microcapsule encapsulating a polyisocyanate.

JP 2002-336379 A discloses a modified golf ball cover composition composed of an isocyanate mixture, wherein the isocyanate mixture is obtained by dispersing an isocyanate compound (X) having at least two isocyanate groups as a functional group in one molecule, in a thermoplastic resin (Y) which is substantially nonreactive with an isocyanate and has rebound resilience of 45% or more.

JP H11-178949 A discloses a solid golf ball comprising a solid core and a cover covering the solid core, wherein a resin component for forming the cover primarily contains a reaction product between a thermoplastic polyurethane elastomer and an isocyanate compound.

JP 2005-533614 A discloses a golf ball comprising a core and a cover, wherein the cover is molded from a thermoplastic material containing a polyurethane, polyurea or polyurethane/polyurea component and having a melt index of 15 g/10 min or more at a temperature of from 200° C. to 210° C. under a load of 8.7 kg before the molding, and the cover is treated with a second curing agent having an isocyanate group after the molding.

JP 2017-80134 A discloses a golf ball comprising a spherical core and a cover covering the spherical core, wherein the cover is formed from a cover composition containing (A) a polyurethane and (B) a polyrotaxane as a resin component, and (B) the polyrotaxane has a cyclodextrin, a linear molecule piercing through the cyclic structure of the cyclodextrin, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

### SUMMARY OF THE INVENTION

As a method for improving the durability of the golf ball, there is a method of softening the cover. However, if the cover is softened, the spin rate on driver shots increases. If the spin rate on driver shots increases, the flight distance on driver shots becomes short. As another method for improving the durability of the golf ball, there is a method of crosslinking a polyurethane constituting the cover. However, if the crosslinked structure is introduced, the hardness of the cover becomes great, and the spin rate on approach shots decreases. If the spin rate on approach shots decreases, the controllability on approach shots is lowered.

In the conventional methods for improving the durability of the golf ball, there is a problem that the hardness of the cover is changed, and as a result of which, the spin rate on driver shots increases or the spin rate on approach shots decreases. The present invention has been achieved in view of the above problems. An object of the present invention is to provide a technology for improving the durability of the golf ball without substantially lowering the spin performance.

The present invention which has solved the above problems provides a golf ball comprising a spherical core and a cover covering the spherical core, wherein the cover contains: (A) a base resin component, and (B) resin fine particles containing a polyrotaxane component having a cyclodextrin, a linear molecule penetrating the cyclic structure of the cyclodextrin in a skewering manner, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

According to the present invention, (B) the resin fine particles containing the polyrotaxane component exist in a state of being dispersed in (A) the base resin component constituting the cover. Thus, it is considered that the hardness of the cover substantially does not change, and the durability of the cover is improved due to the reinforcement effect of (B) the resin fine particles.

According to the present invention, the durability of the golf ball is improved without substantially lowering the spin performance.

### BRIEF DESCRIPTION OF THE DRAWINGS

FIG. 1 is an illustrative figure showing a molecular structure of one example of a polyrotaxane used in the present invention; and

FIG. 2 is a partially cutaway cross-sectional view of a golf ball according to one embodiment of the present invention.

### DESCRIPTION OF THE PREFERRED EMBODIMENT

The present invention provides a golf ball comprising a spherical core and a cover covering the spherical core, wherein the cover contains: (A) a base resin component, and (B) resin fine particles containing a polyrotaxane component having a cyclodextrin, a linear molecule penetrating the cyclic structure of the cyclodextrin in a skewering manner, and blocking groups located at both terminals of the linear molecule to prevent disassociation of the cyclodextrin, wherein at least a part of hydroxyl groups of the cyclodextrin is modified with a caprolactone chain via a —O— C₃H₆—O— group (hereinafter sometimes referred to as “polyrotaxane fine particles”).

First, (B) the polyrotaxane fine particles used in the present invention will be explained. (B) The polyrotaxane fine particles contain a polyrotaxane component. The polyrotaxane component has a cyclodextrin, a linear molecule penetrating the cyclic structure of the cyclodextrin in a skewering manner, and blocking groups located at both terminals of the linear molecule to prevent disassociation of the cyclic molecule. The polyrotaxane is viscoelastic, since the cyclodextrin molecule is movable along the linear molecule that penetrates the cyclodextrin in a skewering manner (pulley effect). Even if a tension is applied to the polyrotaxane, the tension can be uniformly dispersed due to the pulley effect.

The cyclodextrin is a general term for an oligosaccharide having a cyclic structure. The cyclodextrin is, for example, a molecule having 6 to 8 D-glucopyranose residues being linked in a cyclic shape via an α-1,4-glucoside bond. Examples of the cyclodextrin include α-cyclodextrin (number of glucose units: 6), β-cyclodextrin (number of glucose units: 7), and γ-cyclodextrin (number of glucose units: 8), and α-cyclodextrin is preferable. As the cyclodextrin, one type may be used solely, and two or more types may be used in combination.

The linear molecule is preferably a linear molecule piercing through the cyclic structure of the cyclodextrin so that the cyclic structure of the cyclodextrin is rotatable around the linear molecule. Examples of the linear molecule include polyalkylene, polyester, polyether, and polyacrylic acid. Among them, polyether is preferable, polyethylene glycol is particularly preferable. Polyethylene glycol has less steric hindrance, and thus can easily penetrate the cyclic structure of the cyclodextrin in a skewering manner.

The weight average molecular weight of the linear molecule is preferably 5,000 or more, more preferably 6,000 or more, and is preferably 100,000 or less, more preferably 80,000 or less.

The linear molecule preferably has functional groups at both terminals thereof. When the linear molecule has the functional group, the linear molecule easily reacts with the blocking group. Examples of the functional group include a hydroxyl group, carboxyl group, amino group, and thiol group.

The blocking group is not particularly limited, as long as they are located at both terminals of the linear molecule to prevent disassociation of the cyclodextrin from the linear molecule. Examples of the method for preventing the disassociation include a method of using a bulky blocking group to physically prevent the disassociation, and a method of using an ionic blocking group to electrostatically prevent the disassociation. Examples of the bulky blocking group include a cyclodextrin and an adamantyl group. The number of the cyclodextrins penetrated by the linear molecule preferably ranges from 0.06 to 0.61, more preferably ranges from 0.11 to 0.48, and even more preferably ranges from 0.24 to 0.41, if the maximum number thereof is deemed as 1. This is because if the number is less than 0.06, the pulley effect may not be exerted, and if the number exceeds 0.61, the cyclodextrins are very densely located, so that the movability of the cyclodextrin may decrease.

As the polyrotaxane, a polyrotaxane having at least a part of hydroxyl groups of the cyclodextrin being modified with a caprolactone chain, is preferred. Modifying with the caprolactone enhances the compatibility of the polyrotaxane with the polyurethane which is the base resin component constituting the cover. Further, modifying with the caprolactone enhances the flexibility of the polyrotaxane, thereby enhancing the spin performance on approach shots.

As the above modification, for example, the hydroxyl groups of the cyclodextrin are treated with propylene oxide to hydroxylpropylate the cyclodextrin, and then ε-caprolactone is added to perform ring-opening polymerization. As a result of this modification, the caprolactone chain —(CO(CH₂)₅O) nH (n is a natural number of 1 to 100) is linked to the exterior side of the cyclic structure of the cyclodextrin via —O—C₃H₆—O— group. “n” represents the degree of polymerization, and is preferably a natural number of 1 to 100, more preferably a natural number of 2 to 70, and even more preferably a natural number of 3 to 40. At another terminal of the caprolactone chain, a hydroxyl group is formed through the ring-opening polymerization.

The ratio of the hydroxyl groups modified with the caprolactone chain to all the hydroxyl groups (100 mole %) included in the cyclodextrin before the modification is preferably 2 mole % or more, more preferably 5 mole % or more, and even more preferably 10 mole % or more, and is preferably 100 mole % or less, more preferably 90 mole % or less, and even more preferably 80 mole % or less. If the ratio of the hydroxyl groups modified with the caprolactone chain falls within the above range, the flexibility of the polyrotaxane is greater, and thus the spin performance under a wet condition is further enhanced.

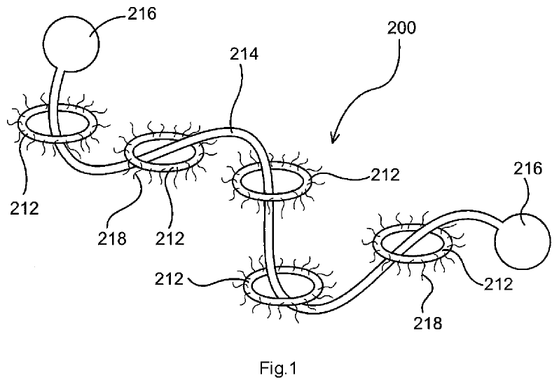

FIG. 1 is an illustrative figure showing a molecular structure of one example of a polyrotaxane used in the present invention. The polyrotaxane 200 has a cyclodextrin 212, a linear molecule 214 piercing through the cyclic structure of the cyclodextrin 212, and blocking groups 216 located at both terminals of the linear molecule 214 to prevent disassociation of the cyclic molecule, wherein a caprolactone chain 218 bonds to an exterior side of the cyclic structure of the cyclodextrin via a —O—C₃H₆—O— group (not shown).

The hydroxyl value of the polyrotaxane is preferably 10 mg KOH/g or more, more preferably 15 mg KOH/g or more, and even more preferably 20 mg KOH/g or more, and is preferably 400 mg KOH/g or less, more preferably 300 mg KOH/g or less, even more preferably 220 mg KOH/g or less, and particularly preferably 180 mg KOH/g or less. This is because if the hydroxyl value of the polyrotaxane falls within the above range, the reactivity with the polyisocyanate is enhanced. It is noted that the hydroxyl value can be measured according to JIS K 1557-1, for example, by an acetylation method.

The total molecular weight of the polyrotaxane is preferably 30,000 or more, more preferably 40,000 or more, and even more preferably 50,000 or more, and is preferably 3,000,000 or less, more preferably 2,500,000 or less, and even more preferably 2,000,000 or less, in a weight average molecular weight. This is because if the weight average molecular weight is less than 30,000, the durability improvement effect is small, and if the weight average molecular weight is more than 3,000,000, the reactivity with the polyisocyanate is lowered. It is noted that the weight average molecular weight can be measured, for example, by gel permeation chromatography (GPC) using polystyrene as a standard substance, tetrahydrofuran as an eluant, and an organic solvent system GPC column (e.g., “Shodex (registered trademark) KF series” available from Showa Denko K.K.) as a column.

(B) The polyrotaxane fine particles are preferably crosslinked resin fine particles, and more preferably one obtained by curing the polyrotaxane component with a polyisocyanate component. This is because if the polyrotaxane component is cured with the polyisocyanate component, the fine particles having the crosslinked structure are easily obtained.

Examples of the polyisocyanate component constituting the crosslinked resin fine particles include an aromatic polyisocyanate such as 2,4-tolylene diisocyanate, 2,6-tolylene diisocyanate, a mixture of 2,4-tolylene diisocyanate and 2,6-tolylene diisocyanate (TDI), 4,4′-diphenylmethane diisocyanate (MDI), 1,5-naphthylene diisocyanate (NDI), 3,3′-bitolylene-4,4′-diisocyanate (TODI), xylylene diisocyanate (XDI), tetramethylxylylene diisocyanate (TMXDI), para-phenylene diisocyanate (PPDI); and an alicyclic polyisocyanate or aliphatic polyisocyanate such as 4,4′-dicyclohexylmethane diisocyanate (H₁₂MDI), hydrogenated xylylene diisocyanate (H₆XDI), hexamethylene diisocyanate (HDI), isophorone diisocyanate (IPDI), and norbornene diisocyanate (NBDI); and derivatives of these polyisocyanates.

The cover of the golf ball according to the present invention preferably contains (B) the polyrotaxane fine particles in an amount of 1 part by mass or more, more preferably in an amount of 2 parts by mass or more, and even more preferably in an amount of 3 parts by mass or more, and preferably in an amount of 20 parts by mass or less, more preferably in an amount of 15 parts by mass or less, and even more preferably in an amount of 10 parts by mass or less, with respect to 100 parts by mass of (A) the base resin component. This is because if the amount of (B) the polyrotaxane fine particles fall within the above range, the durability is enhanced.

The median particle size (particle size at 50% in the volume accumulation distribution) of (B) the polyrotaxane fine particles used in the present invention is preferably 1 μm or more, more preferably 3 μm or more, and even more preferably 5 μm or more, and is preferably 50 μm or less, more preferably 45 μm or less, and even more preferably 40 μm or less. This is because if the median particle size of (B) the polyrotaxane fine particles falls within the above range, the dispersibility of (B) the polyrotaxane fine particles is better.

(B) The polyrotaxane fine particles are preferably spherical.

The cover of the golf ball according to the present invention contains (A) a base resin component. (A) The base resin component may be either a thermoplastic resin or a thermosetting resin, and is preferably the thermoplastic resin.

Examples of the thermoplastic resin include an ionomer resin, a thermoplastic olefin copolymer, a thermoplastic urethane resin, a thermoplastic polyamide resin, a thermoplastic styrene-based resin, a thermoplastic polyester resin, and a thermoplastic acrylic resin. Among these thermoplastic resins, a thermoplastic elastomer having rubber elasticity is preferable. Examples of the thermoplastic elastomer include a thermoplastic urethane elastomer, a thermoplastic polyamide elastomer, a thermoplastic styrene-based elastomer, a thermoplastic polyester elastomer, and a thermoplastic acrylic-based elastomer.

### (A1) Ionomer Resin

Examples of the ionomer resin include an ionomer resin consisting of a metal ion-neutralized product of a binary copolymer composed of an olefin and an α,β-unsaturated carboxylic acid having 3 to 8 carbon atoms; an ionomer resin consisting of a metal ion-neutralized product of a ternary copolymer composed of an olefin, an α,β-unsaturated carboxylic acid having 3 to 8 carbon atoms and an α,β-unsaturated carboxylic acid ester; and a mixture thereof.

It is noted that, in the present invention, “an ionomer resin consisting of a metal ion-neutralized product of a binary copolymer composed of an olefin and an α,β-unsaturated carboxylic acid having 3 to 8 carbon atoms” is sometimes simply referred to as “a binary ionomer resin”, and “an ionomer resin consisting of a metal ion-neutralized product of a ternary copolymer composed of an olefin, an α,β-unsaturated carboxylic acid having 3 to 8 carbon atoms and an α,β-unsaturated carboxylic acid ester” is sometimes simply referred to as “a ternary ionomer resin”.

The olefin is preferably an olefin having 2 to 8 carbon atoms. Examples of the olefin include ethylene, propylene, butene, pentene, hexene, heptene and octene, and ethylene is particularly preferable. Examples of the α,β-unsaturated carboxylic acid having 3 to 8 carbon atoms include acrylic acid, methacrylic acid, fumaric acid, maleic acid and crotonic acid, and acrylic acid or methacrylic acid is particularly preferable. In addition, as the α,β-unsaturated carboxylic acid ester, methyl ester, ethyl ester, propyl ester, n-butyl ester, isobutyl ester or the like of acrylic acid, methacrylic acid, fumaric acid, maleic acid or the like can be used, and acrylic acid ester or methacrylic acid ester is particularly preferable.

As the binary ionomer resin, a metal ion-neutralized product of an ethylene-(meth)acrylic acid binary copolymer is preferable. As the ternary ionomer resin, a metal ion-neutralized product of a ternary copolymer composed of ethylene, (meth)acrylic acid and (meth)acrylic acid ester is preferable. Herein, (meth)acrylic acid means acrylic acid and/or methacrylic acid.

The amount of the α,β-unsaturated carboxylic acid component having 3 to 8 carbon atoms in the binary ionomer resin is preferably 15 mass % or more, more preferably 16 mass % or more, and even more preferably 17 mass % or more, and is preferably 30 mass % or less, more preferably 25 mass % or less. If the amount of the α,β-unsaturated carboxylic acid component having 3 to 8 carbon atoms is 15 mass % or more, the obtained constituent member is easily adjusted to a desired hardness. In addition, if the amount of the α,β-unsaturated carboxylic acid component having 3 to 8 carbon atoms is 30 mass % or less, the obtained constituent member is not excessively hard and hence has better durability and shot feeling.

The neutralization degree of the carboxyl groups of the binary ionomer resin is preferably 15 mole % or more, more preferably 20 mole % or more, and is preferably 100 mole % or less. If the neutralization degree is 15 mole % or more, the obtained golf ball has better resilience and durability. It is noted that the neutralization degree of the carboxyl groups of the binary ionomer resin may be calculated by the following expression. In addition, the metal component may be contained in such a manner that the theoretical neutralization degree of the carboxyl groups of the ionomer resin exceeds 100 mole %.

Neutralization degree of binary ionomer resin (mole %)=100×(mole number of neutralized carboxyl groups in binary ionomer resin/mole number of all carboxyl groups in binary ionomer resin)

Examples of the metal ion for neutralizing at least a part of carboxyl groups of the binary ionomer resin include a monovalent metal ion such as sodium, potassium and lithium; a divalent metal ion such as magnesium, calcium, zinc, barium and cadmium; a trivalent metal ion such as aluminum; and other ion such as tin and zirconium.

Specific examples of the binary ionomer resin in terms of trade names include “Himilan (registered trademark) (e.g. Himilan 1555 (Na), Himilan 1557 (Zn), Himilan 1605 (Na), Himilan 1706 (Zn), Himilan 1707 (Na), Himilan AM7311 (Mg), Himilan AM7329 (Zn)” available from Mitsuli-Du Pont Polychemicals Co., Ltd.

Specific examples of the binary ionomer resin in terms of trade names further include “Surlyn (registered trademark) (e.g. Surlyn 8945 (Na), Surlyn 9945 (Zn), Surlyn 8140 (Na), Surlyn 8150 (Na), Surlyn 9120 (Zn), Surlyn 9150 (Zn), Surlyn 6910 (Mg), Surlyn 6120 (Mg), Surlyn 7930 (Li), Surlyn 7940 (Li), Surlyn AD8546 (Li))” available from E.I. du Pont de Nemours and Company.

Examples of the ionomer resin available from ExxonMobil Chemical Corporation include “Iotek (registered trademark) (e.g. Iotek 8000 (Na), Iotek 8030 (Na), Iotek 7010 (Zn), Iotek 7030 (Zn))”.

The above listed binary ionomer resins may be used solely or as a mixture of two or more of them. Na, Zn, Li, Mg and the like described in the parentheses after the trade names indicate metal types of neutralizing metal ions of the ionomer resins.

The amount of the α,β-unsaturated carboxylic acid component having 3 to 8 carbon atoms in the ternary ionomer resin is preferably 2 mass % or more, more preferably 3 mass % or more, and is preferably 30 mass % or less, more preferably 25 mass % or less.

The neutralization degree of the carboxyl groups of the ternary ionomer resin is preferably 20 mole % or more, more preferably 30 mole % or more, and is preferably 100 mole % or less. If the neutralization degree is 20 mole % or more, the golf ball obtained by using the thermoplastic resin composition has better resilience and durability. It is noted that the neutralization degree of the carboxyl groups of the ionomer resin may be calculated by the following expression. In addition, the metal component may be contained in such a manner that the theoretical neutralization degree of the carboxyl groups of the ionomer resin exceeds 100 mole %.

Neutralization degree of ionomer resin (mole %)=100 ×(mole number of neutralized carboxyl groups in ionomer resin/mole number of all carboxyl groups in ionomer resin)

Examples of the metal ion for neutralizing at least a part of carboxyl groups of the ternary ionomer resin include a monovalent metal ion such as sodium, potassium and lithium; a divalent metal ion such as magnesium, calcium, zinc, barium and cadmium; a trivalent metal ion such as aluminum; and other ion such as tin and zirconium.

Specific examples of the ternary ionomer resin in terms of trade names include “Himilan (e.g. Himilan AM7327 (Zn), Himilan 1855 (Zn), Himilan 1856 (Na), Himilan AM7331 (Na))” available from Mitsui-Du Pont Polychemicals Co., Ltd. Further, examples of the ternary ionomer resin available from E.I. du Pont de Nemours and Company include “Surlyn 6320 (Mg), Surlyn 8120 (Na), Surlyn 8320 (Na), Surlyn 9320 (Zn), Surlyn 9320W (Zn), HPF1000 (Mg), HPF2000 (Mg), etc.)”. In addition, Examples of the ternary ionomer resin available from ExxonMobil Chemical Corporation include “Iotek 7510 (Zn), Iotek 7520 (Zn), etc.)”. It is noted that Na, Zn, Mg and the like described in the parentheses after the trade names indicate types of neutralizing metal ions. The ternary ionomer resin may be used solely, or two or more of them may be used in combination.

### (A2) Thermoplastic Olefin Copolymer

Examples of the thermoplastic olefin copolymer include a binary copolymer composed of an olefin and an α,β-unsaturated carboxylic acid having 3 to 8 carbon atoms; a ternary copolymer composed of an olefin, an α,β-unsaturated carboxylic acid having 3 to 8 carbon atoms and an α,β-unsaturated carboxylic acid ester; and a mixture thereof. The thermoplastic olefin copolymer is a non-ionic copolymer in which the carboxylic groups thereof are not neutralized.

It is noted that, in the present invention, “a binary copolymer composed of an olefin and an α,β-unsaturated carboxylic acid having 3 to 8 carbon atoms” is sometimes simply referred to as “a binary copolymer”, and “a ternary copolymer composed of an olefin, an α,β-unsaturated carboxylic acid having 3 to 8 carbon atoms and an α,β-unsaturated carboxylic acid ester” is sometimes simply referred to as “a ternary copolymer”.

Examples of the olefin include those listed as the olefin constituting the ionomer resin. In particular, the olefin is preferably ethylene. Examples of the α,β-unsaturated carboxylic acid having 3 to 8 carbon atoms and the ester thereof include those listed as the α,β-unsaturated carboxylic acid having 3 to 8 carbon atoms and the ester thereof constituting the ionomer resin.

As the binary copolymer, a binary copolymer composed of ethylene and (meth)acrylic acid is preferable. As the ternary copolymer, a ternary copolymer composed of ethylene, (meth)acrylic acid and (meth)acrylic acid ester is preferable. Herein, (meth)acrylic acid means acrylic acid and/or methacrylic acid.

The amount of the α,β-unsaturated carboxylic acid component having 3 to 8 carbon atoms in the binary copolymer or ternary copolymer is preferably 4 mass % or more, more preferably 5 mass % or more, and is preferably 30 mass % or less, more preferably 25 mass % or less.

Specific examples of the binary copolymer in terms of trade names include an ethylene-methacrylic acid copolymer in a trade name of “NUCREL (registered trademark) (e.g. “NUCREL N1050H”, “NUCREL N2050H”, “NUCREL N1110H”, “NUCREL N0200H”)” available from Mitsui-Du Pont Polychemicals Co., Ltd.; and an ethylene-acrylic acid copolymer in a trade name of “PRIMACOR (registered trademark) 5980I” available from Dow Chemical Corporation.

Specific examples of the ternary copolymer in terms of trade names include trade name “NUCREL (e.g. “NUCREL AN4318” “NUCREL AN4319”)” available from Mitsui-Du Pont Polychemicals Co., Ltd.; trade name “NUCREL (e.g. “NUCREL AE”)” available from E.I. du Pont de Nemours and Company; and trade name “PRIMACOR (e.g. “PRIMACOR AT310”, “PRIMACOR AT320”)” available from Dow Chemical Corporation. The binary copolymer or ternary copolymer may be used solely, or two or more of them may be used in combination.

### (A3) Thermoplastic Polyurethane Resin and Thermoplastic Polyurethane Elastomer

Examples of the thermoplastic polyurethane resin and the thermoplastic polyurethane elastomer include a thermoplastic resin and a thermoplastic elastomer which have a plurality of urethane bonds in the main chain of the molecule. As the polyurethane, a product obtained by a reaction between a polyisocyanate component and a polyol component is preferable. Examples of the thermoplastic polyurethane elastomer include trade names “Elastollan (registered trademark) XNY85A”, “Elastollan XNY90A”, “Elastollan XNY97A”, “Elastollan ET885” and “Elastollan ET890” available from BASF Japan Ltd.

### (A4) Thermoplastic Styrene-Based Elastomer

As the thermoplastic styrene-based elastomer, a thermoplastic elastomer containing a styrene block is suitably used. The styrene block-containing thermoplastic elastomer has a polystyrene block which is a hard segment, and a soft segment. Typical soft segment is a diene block. Examples of the constituent component of the diene block include butadiene, isoprene, 1,3-pentadiene and 2,3-dimethyl-1,3-butadiene. Butadiene and isoprene are preferable. Two or more of the constituent components may be used in combination.

Examples of the thermoplastic elastomer containing the styrene block include a styrene-butadiene-styrene block copolymer (SBS), a styrene-isoprene-styrene block copolymer (SIS), a styrene-isoprene-butadiene-styrene block copolymer (SIBS), a hydrogenated product of SBS, a hydrogenated product of SIS, and a hydrogenated product of SIBS. Examples of the hydrogenated product of SBS include a styrene-ethylene-butylene-styrene block copolymer (SEBS). Examples of the hydrogenated product of SIS include a styrene-ethylene-propylene-styrene block copolymer (SEPS). Examples of the hydrogenated product of SIBS include a styrene-ethylene-ethylene-propylene-styrene block copolymer (SEEPS).

The amount of the styrene component in the thermoplastic elastomer containing the styrene block is preferably 10 mass % or more, more preferably 12 mass % or more, and most preferably 15 mass % or more. From the viewpoint of the shot feeling of the obtained golf ball, the above amount is preferably 50 mass % or less, more preferably 47 mass % or less, and most preferably 45 mass % or less.

Examples of the thermoplastic elastomer containing the styrene block include an alloy of one member or at least two members selected from the group consisting of SBS, SIS, SIBS, SEBS, SEPS, SEEPS and hydrogenated products thereof with a polyolefin. It is estimated that the olefin component in the alloy contributes to the improvement in compatibility with the ionomer resin. If the alloy is used, the resilience performance of the golf ball is enhanced. An olefin having 2 to 10 carbon atoms is preferably used. Suitable examples of the olefin include ethylene, propylene, butene and pentene. Ethylene and propylene are particularly preferable.

Specific examples of the polymer alloy include “TEFABLOC (registered trademark) T3221C”, “TEFABLOC T3339C”, “TEFABLOC SJ4400N”, “TEFABLOC SJ5400N”, “TEFABLOC SJ6400N”, “TEFABLOC SJ7400N”, “TEFABLOC SJ8400N”, “TEFABLOC SJ9400N” and “TEFABLOC SR04” available from Mitsubishi Chemical Corporation. Other specific examples of the thermoplastic elastomer containing the styrene block include “Epofriend A1010” available from Daicel Chemical Industry Co., Ltd., and “SEPTON HG-252” available from Kuraray Co., Ltd.

### (A5) Thermoplastic Polyamide Resin and Thermoplastic Polyamide Elastomer

The thermoplastic polyamide is not particularly limited as long as it is a thermoplastic resin having a plurality of amide bonds (—NH—CO—) in the main chain of the molecule, and examples thereof include a product having amide bonds formed in the molecule through ring-opening polymerization of a lactam, or a reaction between a diamine component and a dicarboxylic acid component.

Examples of the polyamide resin include an aliphatic polyamide such as polyamide 6, polyamide 11, polyamide 12, polyamide 66, polyamide 610, polyamide 6T, polyamide 6I, polyamide 9T, polyamide M5T and polyamide 612; an aromatic polyamide such as poly-p-phenylene terephthalamide and poly-m-phenylene isophthalamide. These polyamides may be used solely, or two or more of them may be used in combination. Among them, the aliphatic polyamide such as polyamide 6, polyamide 66, polyamide 11 and polyamide 12 is preferable.

Specific examples of the polyamide resin in terms of trade names include “Rilsan (registered trademark) B (e.g. Rilsan BESN TL, Rilsan BESN P20 TL, Rilsan BESN P40 TL, Rilsan MB3610, Rilsan BMF O, Rilsan BMN O, Rilsan BMN O TLD, Rlsan BMN BK TLD, Rilsan BMN P20 D, Rilsan BMN P40 D)” available from Arkema K.K.

The polyamide elastomer has a hard segment portion composed of a polyamide component, and a soft segment portion. Examples of the soft segment portion of the polyamide elastomer include a polyether ester component and a polyether component. Examples of the polyamide elastomer include a polyether ester amide obtained by a reaction between a polyamide component (hard segment component) and a polyether ester component (soft segment component) which is formed from a polyoxyalkylene glycol and a dicarboxylic acid; and a polyether amide obtained by a reaction between a polyamide component (hard segment component) and a polyether component (soft segment component) which is formed from a dicarboxylic acid or diamine and a compound obtained by aminating or carboxylating both terminals of a polyoxyalkylene glycol.

Examples of the polyamide elastomer include “PEBAX (registered trademark) 2533”, “PEBAX 3533”, “PEBAX 4033” and “PEBAX 5533” available from Arkema K.K.

### (A6) Thermoplastic Polyester Resin and Thermoplastic Polyester Elastomer

The thermoplastic polyester resin is not particularly limited as long as it has a plurality of ester bonds in the main chain of the molecule, and preferable examples thereof include a product obtained by a reaction between a dicarboxylic acid and a diol. Examples of the thermoplastic polyester elastomer include a block copolymer having a hard segment composed of a polyester component, and a soft segment. Examples of the polyester component constituting the hard segment include an aromatic polyester. Examples of the soft segment component include an aliphatic polyether and an aliphatic polyester.

Specific examples of the polyester elastomer include “Hytrel (registered trademark) 3548” and “Hytrel 4047” available from Du Pont-Toray Co., Ltd., and “Primalloy (registered trademark) A1606”, “Primalloy B1600” and “Primalloy B1700” available from Mitsubishi Chemical Corporation.

### (A7) Thermoplastic (Meth)Acrylic-Based Elastomer

Examples of the thermoplastic (meth)acrylic-based elastomer include a thermoplastic elastomer obtained by copolymerizing ethylene and (meth)acrylic acid ester. Specific examples of the thermoplastic (meth)acrylic-based elastomer include “KURARITY (a block copolymer of methyl methacrylate and butyl acrylate)” available from Kuraray Co., Ltd.

(A) The base resin component of the cover of the golf ball according to the present invention preferably contains the thermoplastic polyurethane. If the base resin component for forming the cover contains the thermoplastic polyurethane, the obtained golf ball has excellent shot feeling and controllability. The amount of the thermoplastic polyurethane in (A) the base resin component for forming the cover is preferably 50 mass % or more, more preferably 70 mass % or more, and even more preferably 90 mass % or more. It is also preferable that (A) the base resin component of the cover consists of the thermoplastic polyurethane.

The cover of the golf ball according to the present invention is formed from the cover composition containing (A) the base resin component and (B) the polyrotaxane fine particles.

The cover composition may further contain (C) an additive. Examples of (C) the additive include a pigment component such as a white pigment (e.g. titanium oxide) and a blue pigment; a weight adjusting agent; a dispersant; an antioxidant; an ultraviolet absorber; a light stabilizer; and a fluorescent material or a fluorescent brightener. Examples of the weight adjusting agent include an inorganic filler such as zinc oxide, barium sulfate, calcium carbonate and magnesium oxide, tungsten powder and molybdenum powder.

The amount of the white pigment (e.g. titanium oxide) is preferably 0.5 part by mass or more, more preferably 1 part by mass or more, and is preferably 10 parts by mass or less, more preferably 8 parts by mass or less, with respect to 100 parts by mass of (A) the base resin component. This is because if the amount of the white pigment is 0.5 part by mass or more, it is possible to impart the opacity to the obtained cover, and if the amount of the white pigment is more than 10 parts by mass, the durability of the obtained cover may deteriorate.

The cover composition may be obtained, for example, by dry blending (A) the base resin component and (B) the polyrotaxane fine particles. Where necessary, (C) the additive may be blended in the cover composition. Further, the dry blended mixture may be extruded into a pellet form. In the dry blending, for example, a mixer capable of blending raw materials in a pellet form is preferably used, a tumbler type mixer is more preferably used. The extrusion can be carried out using a conventional extruder such as a single-screw extruder, a twin-screw extruder, and a twin-screw/single-screw extruder.

It is preferred that the slab hardness (material hardness) of the cover composition is appropriately set in accordance with the desired performance of the golf ball. For example, in case of a so-called distance golf ball which focuses on a flight distance, the cover composition preferably has a slab hardness of 50 or more, more preferably 55 or more, and even more preferably 60 or more, and preferably has a slab hardness of 80 or less, more preferably 70 or less, and even more preferably 68 or less in Shore D hardness. If the cover composition has a slab hardness of 50 or more, the obtained golf ball has a higher launch angle and lower spin rate on driver shots and iron shots, and thus travels a greater flight distance. Further, if the cover composition has a slab hardness of 80 or less, the golf ball excellent in durability is obtained.

In addition, in case of a so-called spin golf ball which focuses on controllability, the cover composition preferably has a slab hardness of less than 50, and preferably has a slab hardness of 20 or more, more preferably 25 or more, and even more preferably 30 or more in Shore D hardness. If the cover composition has a slab hardness of less than 50 in Shore D hardness, the obtained golf ball readily stops on the green due to the high spin rate on approach shots. Further, if the cover composition has a slab hardness of 20 or more in Shore D hardness, the abrasion resistance becomes better. In case of a plurality of cover layers, the slab hardness of the cover composition constituting each layer may be identical to or different from each other.

In the present invention, by containing (B) the polyrotaxane fine particles in the cover composition, the durability of the golf ball can be improved without substantially changing the original hardness of the cover composition. The hardness change rate of the hardness of the cover composition in which (B) the polyrotaxane fine particles are contained with respect to the original hardness of the cover composition in which (B) the polyrotaxane fine particles are not contained is preferably 20% or less, more preferably 10% or less. This is because if the hardness change rate is excessively great, the influence on the spin rate on driver shots or spin rate on approach shots is great.

### [Construction of Golf Ball]

The golf ball according to the present invention is not particularly limited, as long as it comprises a spherical core and a cover covering the spherical core. Examples of the construction of the golf ball include a two-piece golf ball, a three-piece golf ball, and a multi-piece golf ball composed of four or more pieces. The present invention can be applied appropriately to any one of the above golf ball construction.

The spherical core of the golf ball according to the present invention will be explained. The spherical core can be formed from a conventional rubber composition (hereinafter sometimes simply referred to as “core rubber composition”). For example, the core and one-piece golf ball body can be molded by heat pressing a rubber composition containing a base rubber, a co-crosslinking agent and a crosslinking initiator.

As the base rubber, particularly preferred is a high-cis polybutadiene having a cis bond in an amount of 40 mass % or more, preferably 70 mass % or more, and more preferably 90 mass % or more in view of its super resilience. As the co-crosslinking agent, an α,β-unsaturated carboxylic acid having 3 to 8 carbon atoms or a metal salt thereof is preferable, and a metal salt of acrylic acid or a metal salt of methacrylic acid is more preferable. As the metal constituting the metal salt, zinc, magnesium, calcium, aluminum or sodium is preferable, and zinc is more preferable. The amount of the co-crosslinking agent is preferably 20 parts by mass or more and 50 parts by mass or less with respect to 100 parts by mass of the base rubber. As the crosslinking initiator, an organic peroxide is preferably used. Specific examples of the organic peroxide include dicumyl peroxide, 1,1-bis(t-butylperoxy)-3,3,5-trimethylcyclohexane, 2,5-dimethyl-2,5-di(t-butylperoxy) hexane, and di-t-butyl peroxide. Among them, dicumyl peroxide is preferably used. The amount of the crosslinking initiator is preferably 0.2 part by mass or more, more preferably 0.3 part by mass or more, and is preferably 3 parts by mass or less, more preferably 2 parts by mass or less, with respect to 100 parts by mass of the base rubber. In addition, the core rubber composition may further contain an organic sulfur compound. As the organic sulfur compound, diphenyl disulfides, thiophenols or thionaphthols are preferably used. The amount of the organic sulfur compound is preferably 0.1 part by mass or more, more preferably 0.3 part by mass or more, and is preferably 5.0 parts by mass or less, more preferably 3.0 parts by mass or less, with respect to 100 parts by mass of the base rubber. The core rubber composition may further contain a carboxylic acid and/or a salt thereof. As the carboxylic acid and/or the salt thereof, a carboxylic acid having 1 to 30 carbon atoms and/or a salt thereof is preferable. The amount of the carboxylic acid and/or the salt thereof is preferably 1 part by mass or more and 40 parts by mass or less with respect to 100 parts by mass of the base rubber.

The core rubber composition may further contain a weight adjusting agent such as zinc oxide and barium sulfate, an antioxidant, a colored powder, or the like in addition to the base rubber, the co-crosslinking agent, the crosslinking initiator, and the organic sulfur compound. The molding conditions for heat pressing the core rubber composition may be determined appropriately depending on the rubber formulation. Generally, the heat pressing is preferably carried out at 130° C. to 200° C. for 10 to 60 minutes, or carried out in a two-step heating of heating at 130° C. to 150° C. for 20 to 40 minutes followed by heating at 160° C. to 180° C. for 5 to 15 minutes.

The golf ball according to the present invention comprises at least one cover layer, and may comprise two or more cover layers. In a case of two or more cover layers, the outermost cover layer preferably contains (A) the base resin component and (B) the polyrotaxane fine particles. This is because if the outermost cover layer contains (A) the base resin component and (B) the resin fine particles containing the polyrotaxane, the durability of the obtained golf ball is enhanced.

In the case that the golf ball according to the present invention comprises two or more cover layers, there is an inner cover layer between the spherical core and the outermost cover layer. Examples of the material constituting the inner cover layer include (A) the base resin component described above. In addition, the inner cover layer may further contain a weight adjusting agent such as barium sulfate and tungsten powder, an antioxidant, a pigment, or the like. It is noted that the inner cover layer is sometimes referred to as an intermediate layer or an outer core layer depending on the construction of the golf ball.

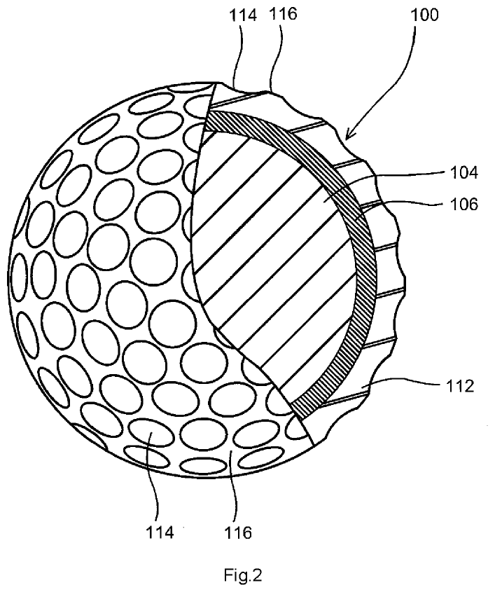

FIG. 2 is a partially cutaway cross-sectional view of a golf ball 100 according to one embodiment of the present invention. The golf ball 100 comprises a spherical core 104, an intermediate layer 106 covering the spherical core 104, and a cover 112 covering the intermediate layer 106. A plurality of dimples 114 are formed on the surface of the cover 112. Other portion than the dimples 114 on the surface of the golf ball is a land 116. The golf ball is provided with a paint layer and a mark layer outside the cover, but these layers are not depicted.

In the present invention, the thickness of the cover of the golf ball is not particularly limited, and is preferably 4 mm or less, more preferably 2 mm or less, and even more preferably 1 mm or less. This is because if the thickness of the cover is 4 mm or less, the outer diameter of the core is greater, and thus the resilience performance can be enhanced. The lower limit of the thickness of the cover is not particularly limited, and, for example, is preferably 0.3 mm, more preferably 0.4 mm, and even more preferably 0.5 mm. If the thickness of the cover is less than 0.3 mm, the cover may be hardly molded. It is noted that in the case that the golf ball according to the present invention comprises a plurality of cover layers, the total thickness of all the cover layers preferably falls within the above range.

The embodiment for molding the cover from the cover composition is not particularly limited, and examples thereof include an embodiment comprising injection molding the cover composition directly onto the core; and an embodiment comprising molding the cover composition into hollow shells, covering the core with a plurality of the hollow shells and compression molding the core with a plurality of the hollow shells (preferably an embodiment comprising molding the cover composition into half hollow-shells, covering the core with two of the half hollow-shells and compression molding the core with two of the half hollow-shells). The golf ball body having the cover molded thereon is ejected from the mold, and as necessary, the golf ball body is preferably subjected to surface treatments such as deburring, cleaning, and sandblast. If desired, a mark may be formed.

The total number of dimples formed on the cover is preferably 200 or more and 500 or less. If the total number is less than 200, the dimple effect is hardly obtained. On the other hand, if the total number exceeds 500, the dimple effect is hardly obtained because the size of the respective dimples is small. The shape (shape in a plan view) of dimples includes, for example, without limitation, a circle, a polygonal shape such as a roughly triangular shape, a roughly quadrangular shape, a roughly pentagonal shape, a roughly hexagonal shape, and other irregular shape. The shape of dimples is employed solely or at least two of them may be used in combination.

The golf ball preferably has a diameter in a range of from 40 mm to 45 mm. In light of satisfying a regulation of US Golf Association (USGA), the diameter is preferably 42.67 mm or more. In light of prevention of air resistance, the diameter is preferably 44 mm or less, more preferably 42.80 mm or less. The golf ball preferably has a mass of 40 g or more and 50 g or less. In light of obtaining greater inertia, the mass is preferably 44 g or more, more preferably 45.00 g or more. In light of satisfying a regulation of USGA, the mass is preferably 45.93 g or less.

When the golf ball according to the present invention has a diameter in a range of from 40 mm to 45 mm, the compression deformation amount of the golf ball (shrinking amount of the golf ball along the compression direction) when applying a load from 98 N as an initial load to 1275 N as a final load to the golf ball is preferably 2.0 mm or more, more preferably 2.1 mm or more, and even more preferably 2.2 mm or more, and is preferably 4.5 mm or less, more preferably 4.3 mm or less, and even more preferably 4.1 mm or less. If the compression deformation amount Is 2.0 mm or more, the golf ball does not become excessively hard, and thus the shot feeling thereof becomes better. On the other hand, if the compression deformation amount is 4.5 mm or less, the resilience of the golf ball becomes higher.

### EXAMPLES

Next, the present invention will be described in detail by way of examples. However, the present invention is not limited to the examples described below. Various changes and modifications without departing from the spirit of the present invention are included in the scope of the present invention.

### [Evaluation Methods]

### (1) Slab Hardness (Shore D Hardness, Shore A Hardness)

Sheets with a thickness of about 2 mm were produced by injection molding the cover composition. The sheets were stored at 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D” or “Shore A”.

### (2) Spin Rate on Approach Shots

An approach wedge (RTX588 (52°) available from Cleveland Golf) was installed on a swing robot M/C available from Golf Laboratories, Inc. The golf ball was hit at a head speed of 16 m/sec, and the spin rate (rpm) thereof was measured by continuously taking a sequence of photographs of the hit golf ball. The measurement was conducted ten times for each golf ball, and the average value thereof was adopted as the spin rate.

### (3) Compression Deformation Amount (mm)

A compression deformation amount of the spherical body (core, golf ball, etc.) (a shrinking amount of the spherical body along the compression direction), when applying a load from an initial load of 98 N to a final load of 1275 N to the spherical body, was measured.

### (4) Durability

A W #1 driver provided with a metal head was installed on a swing robot M/C available from Golf Laboratories, Inc. Each golf ball was hit at a head speed of 45 m/sec to be allowed to collide a collision plate. This was repeated until the golf ball was broken, and the hitting number when the golf ball was broken was counted. The hitting number of the golf ball No. 1 was defined as 100, and the durability of each golf ball was represented by converting the hitting number of each golf into this index. A greater value represented by converting the hitting number of each golf ball into this index means better durability of the golf ball.

### (5) Measurement of Median Size

The test sample was set in a dry type unit of a laser diffraction particle size measuring apparatus (LMS-2000e type available from Seishin Enterprise Co., Ltd.), and the particle size thereof was measured at a test sample refractive index of 1.52. The median size (d50) was obtained from the obtained volume-based histogram.

### [Production of Golf Ball]

### (1) Production of Core

According to the formulations shown in Table 1, the core rubber compositions were kneaded, and heat pressed in upper and lower molds, each having a hemispherical cavity, at 170° C. for 15 minutes to obtain spherical cores (diameter: 38.5 mm). Subsequently, according to the formulations shown in Table 1, the intermediate layer materials were extruded with a twin-screw kneading extruder to prepare the intermediate layer compositions in a pellet form. The extruding conditions were a screw diameter of 45 mm, a screw rotational speed of 200 rpm, and screw L/D=35, and the mixture was heated to 150 to 230° C. at the die position of the extruder. The obtained intermediate layer composition was injection molded onto the spherical core obtained above to produce a spherical body (diameter: 41.7 mm) comprising a spherical core and an intermediate layer covering the spherical core.

TABLE 1
Spherical body (spherical core + intermediate layer)

| Spherical core | Formulation | Polybutadiene rubber | 100 |
|---|---|---|---|
| | (parts by mass) | Zinc acrylate | 38 |
| | | Zinc oxide | 5 |
| | | Diphenyl disulfide | 0.5 |
| | | Dicumyl peroxide | 1 |
| | Diameter (mm) | | 38.5 |
| Intermediate layer | Formulation | Himilan 1605 | 50 |
| | (parts by mass) | Himilan AM7329 | 50 |

| | | |
|---|---|---|
| | Slab hardness (Shore D) | 64 |
| | Thickness (mm) | 1.6 |
| Properties | Diameter (mm) | 41.7 |
| | Compression deformation amount (mm) | 2.6 |

Polybutadiene rubber: “BR730 (high-cis polybutadiene)” available from JSR Corporation

Zinc acrylate: “ZNDA-90S” available from Nisshoku Techno Fine Chemical Co., Ltd.

Zinc oxide: “Ginrei R” available from Toho Zinc Co., Ltd.

Diphenyl disulfide: available from Sumitomo Seika Chemicals Co., Ltd.

Dicumyl peroxide: “Percumyl (registered trademark) D” available from NOF Corporation

Himilan (registered trademark) 1605: Na-neutralized ethylene-methacrylic acid copolymer ionomer resin available from Du Pont-Mitsui Polychemicals Co., Ltd.

Himilan AM7329: Zinc-neutralized ethylene-methacrylic acid copolymer ionomer resin available from Du Pont-Mitsui Polychemicals Co., Ltd.

### (2) Molding of Half Shell

According to the formulations shown in Table 2, the materials were dry blended, and mixed with a twin-screw kneading extruder to prepare the cover compositions in a pellet form. The extruding conditions were a screw diameter of 45 mm, a screw rotational speed of 200 rpm, and screw L/D=35, and the mixture was heated to 150 to 230° C. at the die position of the extruder. The compression molding of the half shells was conducted by charging each of the obtained cover compositions in the pellet form into each of the depressed part of the lower mold for molding half shells, and applying pressure to mold the half shells. The compression molding was conducted under the conditions of a molding temperature of 170° C., a molding time of 5 minutes and a molding pressure of 2.94 MPa.

### (3) Molding of Cover

The spherical body obtained by (1) was concentrically covered with two of the half shells obtained by (2), and the compression molding was conducted to obtain the cover. The compression molding was conducted under the conditions of a molding temperature of 145° C., a molding time of 2 minutes and a molding pressure of 9.8 MPa. The surface of the obtained golf ball body was subjected to a sandblast treatment, and a mark was formed thereon. Then, a clear paint was applied to the golf ball body, and the paint was dried in an oven of 40° C. to obtain a golf ball having a diameter of 42.7 mm and a mass of 45.3 g. Evaluation results of the obtained golf balls are shown in Table 2.

TABLE 2

| | | Golf ball No. | | | | | | |
|---|---|---|---|---|---|---|---|---|
| | | 1 | 2 | 3 | 4 | 5 | 6 | 7 |
| Cover | Elastollan XNY88A | 100 | 100 | 100 | 100 | 100 | 100 | 100 |
| composition | Titanium oxide | 4 | 4 | 4 | 4 | 4 | 4 | 4 |
| | Crossnate EM | — | 10 | — | — | — | — | — |
| | SH2400B-0501 (particle size: 7.4 μm) | — | — | 25 | 3 | 10 | 20 | — |
| | SH2400B-2001 (particle size: 20 μm) | — | — | — | — | — | — | 10 |
| | Shore A hardness | 88 | 91 | 88 | 88 | 88 | 88 | 88 |
| Golf | Spin rate on approach shots (rpm) | 4250 | 4050 | 4280 | 4250 | 4250 | 4250 | 4250 |
| ball | Durability | 100 | 110 | 100 | 102 | 108 | 110 | 108 |

Formulation: parts by mass

The materials used in Table 2 are shown below.

Elastollan XNY88A: polyurethane elastomer (Shore A hardness: 88) available from BASF Japan Ltd

Titanium oxide: titanium dioxide A220 available from Ishihara Sangyo Kaisha, Ltd.

Polyrotaxane fine particles SH2400B-0501 available from Advanced Softmaterials Inc.: crosslinked resin fine particles obtained by curing polyrotaxane with polyisocyanate, median particle size: 7.4 μm, decomposition starting temperature: 306° C.

Polyrotaxane fine particles SH2400B-2001 available from Advanced Softmaterials Inc.: crosslinked resin fine particles obtained by curing polyrotaxane with polyisocyanate, median particle size: 20 μm, decomposition starting temperature: 306° C.

Crossnate EM: isocyanate master batch obtained by dispersing MDI (4,4′-diphenyl methane diisocyanate) in a polyester elastomer (MDI amount: 30 mass %), available from Dainichiseika Color & Chemicals Mfg. Co., Ltd.

It can be seen from the results of Table 2 that, the golf ball according to the present invention comprising a cover containing: (A) a base resin component, and (B) a resin fine particles containing a polyrotaxane component having a cyclodextrin, a linear molecule penetrating the cyclic structure of the cyclodextrin in a skewering manner, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group, has improve durability without substantially lowering the spin performance.

It can be seen that the golf ball No. 2 which is the case that the polyurethane for forming the cover is crosslinked with Crossnate EM, has a high hardness in the cover and hence has a decreased spin rate on approach shots, although the golf ball No. 2 has enhanced durability.

The present invention is suitably applied to a golf ball comprising a cover.

This application is based on Japanese patent application No. 2018-195344 filed on Oct. 16, 2018, the content of which is hereby incorporated by reference.

1. A golf ball comprising a spherical core and a cover covering the spherical core, wherein the cover contains:
(A) a base resin component, and
(B) resin fine particles containing a polyrotaxane component having a cyclodextrin, a linear molecule penetrating the cyclic structure of the cyclodextrin in a skewering manner, and blocking groups located at both terminals of the linear molecule to prevent disassociation of the cyclodextrin, wherein at least a part of hydroxyl groups of the cyclodextrin is modified with a caprolactone chain via a —O—C₃H₆—O— group.

2. The golf ball according to claim 1, wherein the cover contains (B) the resin fine particles in an amount of from 1 part by mass to 20 parts by mass with respect to 100 parts by mass of (A) the base resin component.

3. The golf ball according to claim 1, wherein (B) the resin fine particles have a median size of from 1 μm to 50 μm.

4. The golf ball according to claim 1, wherein (B) the resin fine particles are a crosslinked resin fine particles.

5. The golf ball according to claim 4, wherein the crosslinked resin fine particles are a product obtained by a reaction between the polyrotaxane component and a polyisocyanate component.

6. The golf ball according to claim 1, wherein the linear molecule of the polyrotaxane is polyethylene glycol, and the blocking group of the polyrotaxane is an adamantyl group.

7. The golf ball according to claim 1, wherein (A) the base resin component forming the cover is a thermoplastic resin.

8. The golf ball according to claim 7, wherein the thermoplastic resin includes a thermoplastic polyurethane.

9. The golf ball according to claim 1, wherein the cover is composed of at least one layer, and an outermost cover layer contains (A) the base resin component and (B) the resin fine particles.

10. The golf ball according to claim 9, wherein the cover is composed of at least two layers, and an inner cover layer disposed between the spherical core and the outermost cover layer contains a thermoplastic resin as a base resin.

11. The golf ball according to claim 10, wherein the thermoplastic resin forming the inner cover layer is an ionomer resin.

12. The golf ball according to claim 10, wherein the inner cover layer has a slab hardness of 50 or more in Shore D hardness.

13. The golf ball according to claim 10, wherein (A) the base resin component forming the outermost cover layer is a thermoplastic resin.

14. The golf ball according to claim 13, wherein the thermoplastic resin forming the outermost cover layer includes a thermoplastic polyurethane.

15. The golf ball according to claim 14, wherein the golf ball is a three-piece golf ball.

16. The golf ball according to claim 1, wherein (B) the resin fine particles are spherical.

17. The golf ball according to claim 1, wherein (B) the resin fine particles have a median size of from 5 μm to 40 μm.
